(19) United States
(12) Patent Application Publication
(10) Pub. No.: US 2025/0111974 A1
(43) Pub. Date: Apr. 3, 2025

(54) MODULES INCLUDING HAPTIC ENGINES

(71) Applicant: Apple Inc., Cupertino, CA (US)

(72) Inventors: Darya Amin-Shahidi, Menlo Park, CA (US); Scott D. Ridel, San Mateo, CA (US); Jinhong Qu, Santa Clara, CA (US)

(21) Appl. No.: 18/742,904

(22) Filed: Jun. 13, 2024

Related U.S. Application Data
(60) Provisional application No. 63/541,720, filed on Sep. 29, 2023.

(51) Int. Cl. H01F 7/08; H01H 13/14; H04M 1/02

(52) U.S. Cl. CPC H01F 7/081; H01H 13/14; H04M 1/026; H01H 2215/05

(57) ABSTRACT

A device includes a frame and a haptic engine. The frame defines at least one flexure. The haptic engine includes a core attached to the frame, an attraction plate attached to the at least one flexure, and an electric coil wound around at least a portion of the core. The attraction plate is separated from the core by a gap. The electric coil, when energized, creates a magnetic field that causes a width of the gap to temporarily change. Some embodiments include a cushioning pad positioned within the gap or a layer of compliant material that attaches the attraction plate to the at least one flexure or the frame.

### CROSS-REFERENCE TO RELATED APPLICATION(S)

This application is a nonprovisional and claims the benefit under 35 U.S.C. § 1.119 (e) of U.S. Provisional Patent Application No. 63/541,720, filed Sep. 29, 2023, the contents of which are incorporated herein by reference as if fully disclosed herein.

### FIELD

The described embodiments generally relate to electronic devices and, more particularly, to modules having haptic engines. In some embodiments, a user's press on a button coupled to a haptic engine may be acknowledged by a haptic output provided to the button by the haptic engine.

### BACKGROUND

Modern consumer electronic devices take many shapes and forms and have numerous uses and functions. Smartphones, wearables devices, including wrist-worn devices (e.g., watches or fitness tracking devices) and head-mounted devices (e.g., headsets, glasses, or earbuds), hand-held devices (e.g., styluses, electronic pencils, or communication or navigation devices), computers (e.g., tablet computers or laptop computers), and dashboards, for example, provide various ways for users to interact with others. Such devices may include numerous systems to facilitate such interactions. For example, a smartphone or computer may include a touch-sensitive display for accepting touch or force inputs and providing a graphical output, and many types of electronic devices may include wireless communications systems (e.g., for connecting with other devices to send and receive voice and data content); one or more cameras (e.g., for capturing photographs and videos); or one or more buttons (e.g., depressible buttons, rocker buttons, or crowns (rotatable buttons) that a user may press or otherwise manipulate to provide input to an electronic device).

### SUMMARY

The term embodiment and like terms (e.g., implementation, configuration, aspect, example, and option) are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter. This summary is also not intended to be used in isolation to determine the scope of the claimed subject matter. The subject matter should be understood by reference to appropriate portions of the entire specification of this disclosure, the drawings, and each claim.

Some aspects of this disclosure are directed to a module having a frame and a haptic engine. The frame may define at least one flexure. The haptic engine may include a core attached to the frame, an attraction plate attached to the at least one flexure, and an electric coil wound around at least a portion of the core. The attraction plate may be separated from the core by a gap. The electric coil, when energized, may create a magnetic field that causes a width of the gap to temporarily change.

Some aspects of this disclosure are directed to another module having a frame and a haptic engine. The haptic engine may include a core, an attraction plate, and an electric coil wound around at least a portion of the core. The core may be coupled to the frame. The attraction plate may also be coupled to the frame, interior to the frame. The attraction plate may be separated from the core by a gap. The electric coil, when energized, may create a magnetic field that causes a width of the gap to temporarily change.

Some aspects of this disclosure are directed to another module having a frame and a haptic engine. The haptic engine may include a core attached to the frame, an attraction plate attached to the frame, and an electric coil wound around at least a portion of the core. The attraction plate may be separated from a surface of the core by a gap. The electric coil, when energized, may create a magnetic field that causes a width of the gap to temporarily change. A cushioning pad may be positioned within the gap, on at least one of the attraction plate or the surface of the core. The cushioning pad may include a first material that has a lower hardness than a second material of the core and a third material of the attraction plate.

Some aspects of this disclosure are directed to another module having a frame and a haptic engine. The haptic engine may include a core attached to the frame, an attraction plate separated from a surface of the core by a gap, and an electric coil wound around at least a portion of the core. The electric coil, when energized, may create a magnetic field that causes a width of the gap to temporarily change. A layer of compliant material may attach the attraction plate to the frame.

Some aspects of this disclosure are directed to a device having a device housing, a frame internal to the device housing, and a haptic engine. The haptic engine may include a core attached to the frame, an attraction plate disposed between the device housing and the core, and an electric coil wound around at least a portion of the core. The attraction plate may be separated from the core by a gap. The electric coil, when energized, may create a magnetic field that causes a width of the gap to temporarily change.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the described embodiments, when taken in connection with the accompanying drawings and the appended claims. Additional aspects of the disclosure will be apparent to those of ordinary skill in the art in view of the detailed description of various embodiments, which is made with reference to the drawings, a brief description of which is provided below.

### BRIEF DESCRIPTION OF THE DRAWINGS

The disclosure will be readily understood by the following detailed description in conjunction with the accompanying drawings, wherein like reference numerals designate like structural elements, and in which:

FIGS. 1A, 1B, and 1C show a front isometric view, a rear isometric view, and a cross-sectional view of an example electronic device having a button and a haptic engine, according to certain aspects of the present disclosure;

FIG. 1D shows a cross-sectional side view of an example button and haptic engine in the electronic device of FIGS. 1A and 1C, according to certain aspects of the present disclosure;

FIG. 2 shows an exploded isometric view of an example more detailed implementation of the button and haptic engine of FIG. 1D, according to certain aspects of the present disclosure;

FIG. 3A shows a cross-sectional side view of an example haptic module having a frame including a main body and a plate for supporting a haptic engine, while FIGS. 3B and 3C show a bottom isometric view of the plate and a bottom plan view of a central portion of the plate, respectively, according to certain aspects of the present disclosure;

FIGS. 4A, 4B, and 4C show bottom views of three examples of a base plate that can be used in a frame to support the haptic engine of FIG. 3A, according to certain aspects of the present disclosure;

FIG. 5 shows a cross-sectional side view of a right-hand portion of a haptic module, according to certain aspects of the present disclosure;

FIGS. 6A, 6B, and 6C show top views of three example cushioning pads that may be disposed between a core and an attraction plate, according to certain aspects of the present disclosure;

FIGS. 7A and 7B show bottom isometric views of an example portion of a base plate attached to an attraction plate, according to certain aspects of the present disclosure;

FIG. 8A shows a bottom isometric view of an example spacer coupled to an attraction plate of a haptic engine, while FIG. 8B shows a bottom isometric view of the spacer, with attached attraction plate, coupled to a base plate of a frame that houses the haptic engine, according to certain aspects of the present disclosure; and

FIG. 9 shows a cross-sectional side view of an example haptic module, in which an attraction plate of a haptic engine is disposed between a core of the haptic engine and a device housing of a device that includes the haptic module, according to certain aspects of the present disclosure.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

The present disclosure is susceptible to various modifications and alternative forms, and some representative embodiments have been shown by way of example in the drawings and will be described in detail herein. It should be understood, however, that the described embodiments are not intended to be limited to the particular forms disclosed. Rather, the disclosure is to cover all modifications, equivalents, and alternatives falling within the spirit and scope of the described embodiments as defined by the appended claims.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Some of the embodiments described herein are directed to modules having haptic engines and, more particularly, to modules having electromagnetic haptic engines with robust designs. The modules described herein may be used in a handheld, portable, wearable, or other type of device and may include a haptic engine coupled to a frame. The haptic engine may include a core coupled to the frame (e.g., by a pair of flexures), an electric coil wound around at least a portion of the core, and an attraction plate (e.g., a magnetic attraction plate) coupled to the frame. The attraction plate may be coupled to the frame by another one or more flexures, different from the flexures that couple the core to the frame. In some embodiments, the core may be coupled directly or indirectly to a button that is positioned external to a device housing (e.g., a housing of a handheld, portable, or wearable device). When a user presses the button, the core may move slightly toward the attraction plate. One or more force sensors (e.g., one or more strain gauges) attached to the haptic module may be used to detect the user's press. In response to a processor or other circuitry detecting the press, an electrical signal may be applied to the electric coil. Together, the energized electric coil and core may generate a magnetic field, and in some cases a time-varying magnetic field that causes a magnetic attraction between the core and the attraction plate. The magnetic attraction may cause one or both of the core or the attraction plate to move, and in some cases vibrate, to produce a haptic output at the button. In some cases, an electrical signal may be applied to the electric coil, to produce a haptic output, even in the absence of detecting a user press on the button.

In situations where the force applied to the button is too great, the core may crash into the attraction plate, potentially causing damage to the haptic engine. Various design strategies can be used to reduce the prospect of such a crash. For example, in some embodiments, the haptic engine may be supported by a frame having a base plate that defines one or more flexures, and the attraction plate may be attached to the one or more flexures. The flexure(s) may have various designs, and the attraction plate may be attached to the flexure(s) to maximize its structural robustness and reliability, as described herein. As another example, structural robustness may be enhanced by attaching the attraction plate to a plate (e.g., a base plate) of the frame using one or more welds and glue disposed around a perimeter of each weld. In some embodiments, a spacer or a layer of compliant material may attach the attraction plate to the base plate. In some embodiments, a cushioning pad having a softer material than the materials used in the core and the attraction plate may be disposed on surfaces of the core and/or the attraction plate that face each other. In some embodiments, the attraction plate may be disposed between the core and a device housing to which the module is attached, such that the input force on the button deflects the core of the haptic engine away from the attraction plate (instead of towards the attraction plate). One or more of these or other design strategies may be employed, as described herein, to mitigate failure modes that cause the core to crash into the attraction plate and damage the haptic engine. As a result, the modules described herein may provide improved structural robustness and reliability versus other haptic engine and/or module designs.

While the specific haptic modules shown in the figures are described below with respect to a particular handheld electronic device, the embodiments described herein may be used with various electronic devices including, but not limited to, smartphones, wearables devices, including wrist-worn devices (e.g., watches or fitness tracking devices) and head-mounted devices (e.g., headsets, glasses, or earbuds), hand-held devices (e.g., styluses, electronic pencils, or communication or navigation devices), computers (e.g., tablet computers or laptop computers), and dashboards. Although various electronic devices are mentioned, the haptic modules of the present disclosure may also be used in conjunction with other products and combined with various materials.

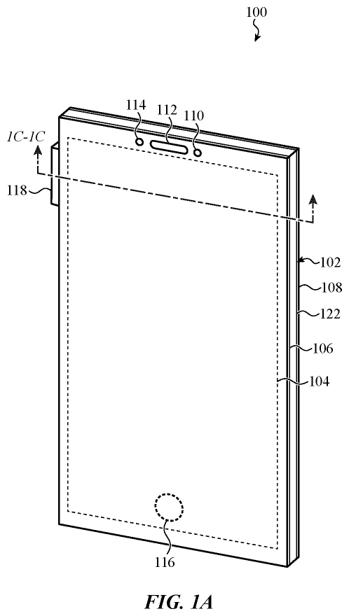

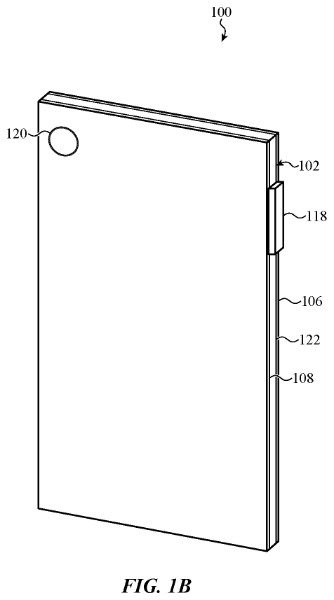

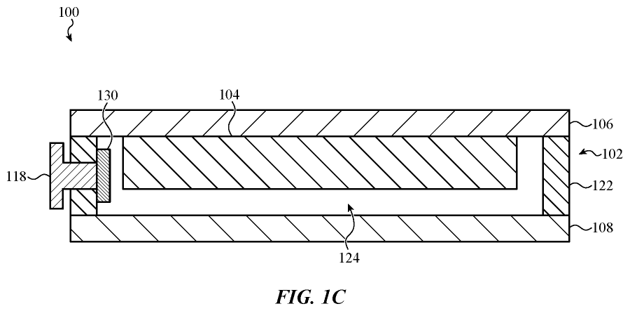

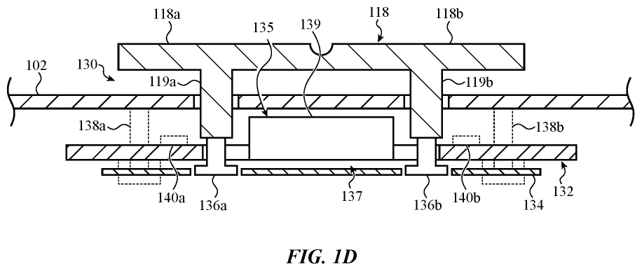

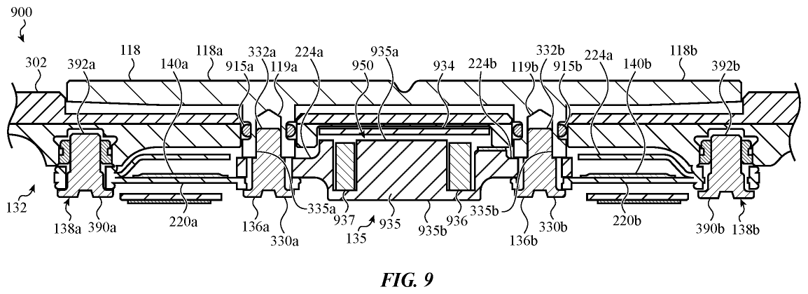

These and other embodiments are discussed below with reference to FIGS. 1A and 9. However, those skilled in the art will readily appreciate that the detailed description given herein with respect to these figures is for explanatory purposes only and should not be construed as limiting.

FIGS. 1A and 1C show an example of an electronic device or simply “device” 100. The device's dimensions and form factor, including the ratio of the length of its long sides to the length of its short sides, suggest that the device 100 is a mobile phone (e.g., a smartphone). However, the dimensions and form factor of the device are arbitrarily chosen, and the device 100 could alternatively be any portable electronic device including, for example a mobile phone, tablet computer, portable computer, portable music player, health monitor device, portable terminal, or other portable or mobile device. FIG. 1A shows a front isometric view of the device 100; FIG. 1B shows a rear isometric view of the device 100; and FIG. 1C shows an example cross-section of the device 100 taken along 1C-1C of FIG. 1A. The device 100 may include a device housing 102 that at least partially surrounds a display 104. The device housing 102 may include or support a front cover 106 or a rear cover 108. The front cover 106 may be positioned over the display 104 and may provide a window through which the display 104 may be viewed. In some embodiments, the display 104 may be attached to (or abut) the device housing 102 and/or the front cover 106.

As shown in FIGS. 1A and 1B, the device 100 may include various other components. For example, the front of the device 100 may include one or more front-facing cameras 110, speakers 112, microphones, or other components 114 (e.g., audio, imaging, or sensing components) that are configured to transmit or receive signals to/from the device 100. In some cases, a front-facing camera 110, alone or in combination with other sensors, may be configured to operate as a bio-authentication or facial recognition sensor. The device 100 may also include various input devices, including a mechanical or virtual button 116, which may be located along the front surface of the device 100. The device 100 may also include one or more buttons or other input devices (e.g., button 118) positioned along a sidewall 122 of the device housing 102 and/or on rear surface of the device 100. By way of example, the rear surface of the device 100 is shown to include a rear-facing camera 120 or another optical sensor (see, FIG. 1B). A flash or light source may also be positioned along the rear of the device 100 (e.g., near the rear-facing camera 120). In some cases, the rear surface of the device may include multiple rear-facing cameras.

As discussed previously, the device 100 may include a display 104 that is at least partially surrounded by the device housing 102. The display 104 may include one or more display elements including, for example, light-emitting display (LED), organic light-emitting display (OLED), liquid crystal display (LCD), electroluminescent display (EL), or other type of display elements. The display 104 may also include one or more touch and/or force sensors that are configured to detect a touch and/or a force applied to a surface of the front cover 106. The touch sensor may include a capacitive array of nodes or elements that are configured to detect a location of a touch on the surface of the front cover 106. The force sensor may include a capacitive array and/or strain sensor that is configured to detect an amount of force applied to the surface of the front cover 106.

FIG. 1C depicts a cross-section of the device 100 shown in FIGS. 1A and 1B taken along 1C-1C of FIG. 1A. As shown in FIG. 1C, the rear cover 108 may be a discrete or separate component that is attached to the sidewall 122. In other cases, the rear cover 108 may be integrally formed with part or all of the sidewall 122.

As shown in FIG. 1C, the sidewall 122 or device housing 102 may define an interior volume 124 in which various electronic components of the device 100, including the display 104, may be positioned. In this example, the display 104 is at least partially positioned within the interior volume 124 and attached to an inner surface of the front cover 106. A touch sensor, force sensor, or other sensing element may be integrated with the front cover 106 and/or the display 104 and may be configured to detect a touch and/or force applied to an outer surface of the front cover 106. In some cases, the touch sensor, force sensor, and/or other sensing element may be positioned between the front cover 106 and the display 104, within or in back of a stack including the display 104, between the front cover and the sidewall 122, or at other locations within the device 100.

In some embodiments, the touch sensor and/or force sensor may include an array of electrodes that are configured to detect a location and/or force of a touch using a capacitive, resistive, strain-based, ultrasonic, or other sensing configuration. The touch sensor may include, for example, a set of capacitive touch sensing elements, a set of resistive touch sensing elements, or a set of ultrasonic touch sensing elements. When a user of the device touches the front cover 106, the touch sensor (or touch sensing system) may detect one or more touches on the front cover 106 and determine locations of the touches on the front cover 106. The touches may include, for example, touches by a user's finger or stylus. A force sensor or force sensing system may include, for example, a set of capacitive force sensing elements, a set of resistive force sensing elements, or one or more pressure transducers. When a user of the device 100 presses on the front cover 106 (e.g., applies a force to the front cover 106), the force sensing system may determine an amount of force applied to the front cover 106. In some embodiments, the force sensor (or force sensing system) may be used alone or in combination with the touch sensor (or touch sensing system) to determine a location of an applied force, or an amount of force associated with each touch in a set of multiple contemporaneous touches.

FIG. 1C further shows the button 118 along the sidewall 122. The button 118 may be accessible to a user of the device 100 and extend outward from the sidewall 122. In some cases, a portion of the button 118 may be positioned within a recess in the sidewall 122. Alternatively, the entire button 118 may be positioned within a recess in the sidewall 122 and the button 118 may be flush with the housing (or inset into the housing).

The button 118 may extend through the housing, and attach to a haptic engine and force sensor disposed within the interior volume 124; the haptic engine and the force sensor are represented in block form by a haptic module 130. Example implementations of button 118 and the haptic module 130 are described in detail elsewhere herein. By way of example, the haptic engine may be an electromagnetic haptic engine. The force sensor may include, for example, a capacitive force sensor, a resistive force sensor (e.g., a strain gauge), a pressure sensor, or a switch (e.g., a compressible switch or a pair of electrical contacts that open or close a circuit when the button 118 is pressed).

The haptic engine of the haptic module 130 may produce a tactile or haptic output in response to the force sensor detecting any force, or in response to the force sensor detecting a force that satisfies a condition. Thus, for example, upon detecting a strain that satisfies a condition (and/or another electrical parameter that is indicative of a force satisfying the condition), the haptic engine may impart a haptic output on the button 118 (e.g., a haptic output resembling a “click”, or a haptic output that is more complex). This haptic output may indicate to the user that the user's press was recognized by the device. In some embodiments, a haptic output may also or alternatively be provided in response to a touch being detected on the button 118. In some embodiments, different haptic outputs may be provided, for example, in response to where a user touches or presses the button 118, or in response to how hard or how long the user presses the button 118, or in response to a context of what is displayed on the display 104 and/or an active application, or in response to an ambient condition of the device 100.

FIG. 1D shows a cross-sectional side view of an example configuration of a button, such as the button 118 of the device 100. A user may press the button 118 toward the device housing 102 (e.g., a device housing) to actuate the button 118 and provide an input to the device 100. In some embodiments, the button 118 may have a singular actuation region. In some embodiments, the button 118 may have a singular shaft that extends through an opening in the device housing 102. The button 118, however, is shown to have different actuation regions 118a, 118b. The button 118 is also shown to include multiple shafts (e.g., first and second shafts 119a, 119b) that extend from the button 118 and through respective openings defined by the device housing 102. The shafts 119a, 119b may be coupled to a base 132, interior to the device housing 102, by one or more fasteners 136a, 136b (e.g., screws, rivets, welded or glued plugs or stops, etc.). Although the embodiments described in this disclosure, are directed to a button 118 that includes two actuation regions and two shafts extending through a device housing, it is understood that different buttons may have more or fewer actuation regions, as well as more or fewer shafts extending from the button and through a device housing.

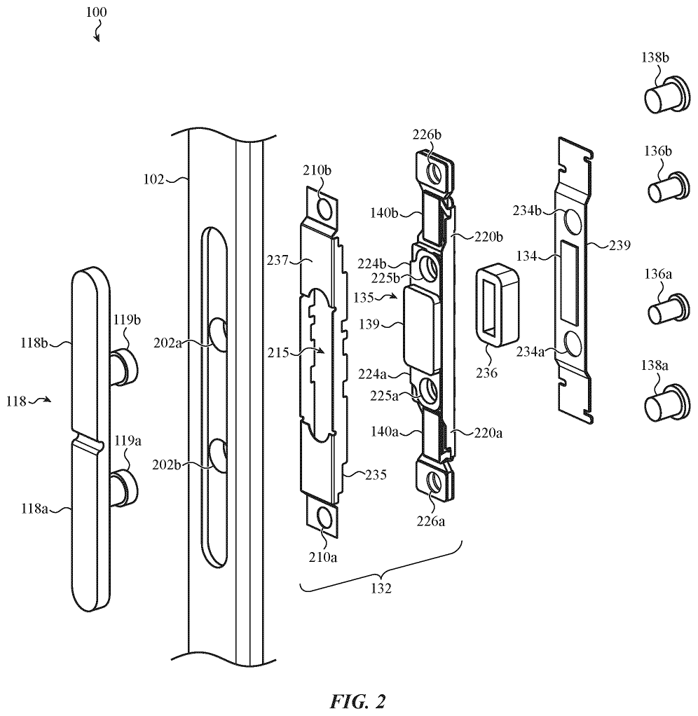

The base 132 shown in FIG. 1D is relatively simplistic and includes a plate (or frame) that may be optionally coupled to the device housing 102 by one or more fasteners 138a, 138b (e.g., one or more screws). In some embodiments, the base 132 may be rigidly attached to the device housing 102. In contrast, the fasteners 136a, 136b may fasten the button 118 to the base 132 such that the button 118 can move with respect to the base 132. The movement may be in any direction, including, for example, up and down, side to side, and into and out of the page given the view shown in FIG. 1D. This allowed movement may enable small misalignments between the holes in the base 132 and the holes in the device housing 102. In the case of a button 118 that sits partially or fully within a cavity (e.g., as shown in FIG. 2), the allowed movement may also allow the button to be centered within the cavity. Compressible gaskets (e.g., O-rings) may surround the shafts 119a, 119b and fill any gaps between the shafts 119a, 119b and the device housing 102. A user's press on the button 118 may hold the button 118 in consistent enough contact with the base 132 for a haptic engine 135 to transfer a haptic output to the button 118 via the base 132.

As shown, each shaft 119a, 119b may have an end that faces a first surface of the base 132, and each fastener 136a, 136b may have a head that faces a second surface of the base 132, such that, after the fasteners 136a, 136b are attached to the shafts 119a, 119b, the base 132 is retained between the ends of the shafts 119a, 119b and the heads of the fasteners 136a, 136b. However, when the end of a shaft 119a or 119b abuts the base 132, the head of a corresponding fastener 136a or 136b does not abut the base 132, and vice versa. Similarly, when the head of a fastener 136a or 136b abuts the base 132, the end of a corresponding shaft 119a or 119b does not abut the base 132.

The haptic engine 135 may be attached to the base 132. The haptic engine 135 may include a core 139, an electric coil disposed around at least a portion of the core 139, and an attraction plate 134, as further discussed herein. In FIG. 1D, the core 139 houses the electric coil (not shown).

In some embodiments, the attraction plate 134 may be attached to the base 132 and separated from the core 139 by a gap 137. In other embodiments, the attraction plate 134 may be attached to another component of the device 100 and separated from the core 139 by a gap 137. In other embodiments, the attraction plate 134 may be positioned between the core 139 and the device housing 102 and attached, for example, to the device housing 102 or to the base 132.

The shafts 119a, 119b may be fastened to the base 132 such that forces applied to the button 118 may be transferred to the base 132, and such that a haptic output applied to the base 132 (e.g., due to operation of the haptic engine 135) may be transferred to the button 118.

One or more sensing elements 140a, 140b (e.g., force sensors) coupled to the base 132 may detect deflection of the base 132 as a result of a force applied to the button 118. The sensing elements 140a, 140b may include, for example, strain sensing elements (e.g., strain gauges, piezoelectric and/or piezoresistive materials, etc.) or other components or materials that detect deflection of the base 132 (optionally in conjunction with other circuitry). Each of the sensing elements 140a, 140b may produce a respective electrical signal that varies with the deflection of the base 132. The device 100 may determine, based at least in part on the signal(s) produced by the sensing element(s) 140a, 140b, the presence of a force on the button 118 and, in some cases, a location of a force on the button 118 (e.g., a force applied to actuation region 118a versus a force applied to actuation region 118b). The device 100 may correlate different combinations of signals received from two or more sensing elements 140a, 140b to different locations of an applied force, and may perform different actions or operations based at least in part on the location of an applied force, an amount or duration of the applied force, and/or whether the location or amount or duration of the applied force satisfies one or more conditions for a particular action or operation to be performed.

When the button 118 is pressed, the press causes the base 132 to deflect. The base 132 may be constrained, relative to the device housing 102, such that forces imparted by the button 118 (e.g., forces in a vertical direction relative to the orientation of FIG. 1D) cause the base 132 to be deflected relative to the device housing 102 and/or other components of the device 100. In some cases, one or both ends of the base 132 may be fixed relative to the device housing 102 (and optionally relative to the attraction plate 134). In some cases, one or both ends of the base 132 may be constrained in one direction (e.g., vertical), but movement may be allowed in another direction (e.g., a horizontal direction). One or both ends of the base 132 may be constrained in various ways, such as by the fasteners 138a, 138b that are coupled to the device housing 102.

The base 132 may generally bias the button 118 to an undepressed or unactuated position and may have a stiffness that provides a tactile resistance to an input force (such that the user can tactilely feel that they are pressing against a button that has some compliance while also providing some resistance). The tactile resistance may increase as the base 132 is deflected, such that the user can feel the increasing resistance as the button is pressed.

The haptic engine 135 attached to the base 132 may be activated in response to a press of the button 118 (e.g., when the user presses the button with sufficient force and/or a sufficient distance to cause the device to register an input). When activated, the core of the haptic engine 135 may attract or repulse the attraction plate 134, which is spaced apart from the core 139 by a gap 137. The attraction and/or repulsion deflects the base 132 and moves the button 118 toward or away from the exterior of the device housing 102. In some embodiments, the button 118 may be configured such that the deflection caused by the haptic engine 135 is less than a dimension of the gap 137, such that the base 132 does not contact the attraction plate 134 during its haptic movement.

The haptic engine 135 may initiate the haptic output when the button 118 has moved a particular distance (and/or in response to another input condition being satisfied) and may move the button 118. The movement of the button 118 (e.g., movement of the button 118 away from the user's finger, followed by a subsequent release of the button 118) may be perceived by a user as a button “click,” which may provide tactile feedback to the user that an input has been registered. The haptic engine 135 may also cycle between pushing and pulling the button 118 to produce oscillations or other haptic effects.

The haptic engine 135 may be configured to produce haptic outputs in response to various input conditions being satisfied, and the device 100 may perform different operations in response to the different input conditions being satisfied (e.g., different amounts of force and/or deflection thresholds being met, different locations of force, and/or different durations of an applied force). Haptic outputs may also have different durations. The particular duration of a haptic output may depend on various factors, including but not limited to a state or mode of operation of the device (e.g., an application that is being executed, a user interface that is being displayed, etc.), a type of input condition that is satisfied and/or triggers the haptic output, an amount of force applied to the button, a duration of an input, and the like.

FIG. 2 shows an exploded isometric view of an example more detailed implementation of the button and haptic engine 135 described with reference to FIG. 1D. The device 100 may include a device housing 102 (e.g., a device housing). The device housing 102 may define a first opening 202a and a second opening 202b. The button 118 may be positioned external to the device housing 102, and the haptic engine 135 may be positioned internal to the device housing 102. Two shafts 119a, 119b may extend from the button 118. The button 118 may include actuation regions 118a, 118b that are more or less aligned with (or associated with) respective one of the shafts 119a, 119b. The shafts 119a, 119b may extend through respective ones of the first and second openings 202a, 202b in the device housing 102, and may be attached to the base 132.

The haptic engine 135 may include a core 139 and an electric coil 236 disposed around at least a portion of the core 139. The core 139 may be formed from a ferromagnetic material, ferrimagnetic material, or other suitable material (e.g., iron, ferrite, steel, ferrous materials, a permanent magnet, iron alloys, etc.). In order to produce a haptic output at the button 118, the electric coil 236 surrounding the core 139 may be energized (e.g., by a circuit that applies a current or current waveform to the electric coil 236), which causes the core 139 to be attracted to the attraction plate 134. The core 139 may have a first tab 224a and a second tab 224b extending from respective opposite sides of the core 139. The first tab 224a may have a first aperture 225a that receives a first fastener 136a that fastens the first tab 224a to the button 118. The second tab 224b may have a second aperture 225b that receives a second fastener 136b that fastens the second tab 224b to the button 118. The first and second tabs 224a, 224b may be considered part of a base 132.

The haptic module 130 of the device 100 may include the base 132 and the haptic engine 135. In addition to the tabs 224a, 224b (or other means for connecting the button 118 to the core 139), the base 132 may include a pair of flexures 220a, 220b and a frame 235. The pair of flexures 220a, 220b may be coupled to the tabs 224a, 224b, and thereby to the core 139. In some embodiments, the flexures 220a, 220b may be welded to the tabs 224a, 224b, and thereby to the core 139. The frame 235 may include a main body 237 and a plate (e.g., a base plate) 239. The frame 235 shown in FIG. 2 is merely an example and, in different embodiments, the frame 235 may incorporate a variety of designs. The flexures 220a, 220b may also be coupled to opposite ends of the main body 237. The frame 235 may include a main body 237 having a central opening 215 and respective apertures 210a, 210b along flanged ends thereof. Each of the two flexures 220a, 220b may include respective apertures 226a, 226b that are distal from the core 139. The apertures 226a, 226b of the flexures 220a, 220b align with the respective apertures 210a, 210b of the frame 235. Fasteners 138a, 138b aligned with the apertures 210a/226a or 210b/226b may couple the flexures 220a, 220b to both the frame 235 and the device housing 102. In some embodiments, the flexures 220a, 220b may also be welded to respective portions of the frame 235 (e.g., near or around the apertures 210a/226a and 210b/226b).

The two flexures 220a, 220b may have respective sensing elements 140a, 140b (e.g., strain gauges) mounted thereon, which sensing elements 140a, 140b can detect and/or measure deflections of the respective flexures 220a, 220b in response to a force applied by a user to the button 118.

The attraction plate 134 may be attached to the plate 239 of the frame 235 and, as described with reference to other figures, may be attached to one or more flexures formed in the plate 239. The attraction plate 134 may be attached to the plate 239, for example, by means of welds, glue, a compliant material, or a combination thereof. The plate 239 may be attached to the main body 237 of the frame 235 by means of welds or crimping, for example. The plate 239 may include a pair of apertures 234a, 234b that allow the fasteners 136a, 136b to pass through the plate 239 without contacting the plate 239.

When a user presses on the button 118, an applied force is transferred from the button to one or both of the tabs 224a, 224b. Because the tabs 224a, 224b are attached to the core 139, the force moves the core 139 toward the attraction plate 134, reducing the size of a gap therebetween. Because the tabs 224a, 224b are attached to the flexures 220a, 220b, the flexures may flex, and the sensing elements 140a, 140b may generate one or more electrical signals indicating that the button 118 has been pressed. In some cases, the one or more electrical signals may indicate a location of the press and/or an amount of force associated with the press. In response to a processor or other circuit (not shown) determining the presence of a user-applied force on the button 118, or the presence of a force having a particular magnitude, and/or a force applied at a particular location, the processor or other circuit may apply an electrical signal to the electric coil 236, which electrical signal, in combination with the electric coil 236 and the core 139, may create a magnetic field that causes the core 139 to be attracted to the attraction plate 134, thereby moving the button 118 to provide a haptic output at the button 118. Modulation of the electrical signal applied to the electric coil 236 may cause the button 118 to move in a desired way, to provide a desired haptic output. In some embodiments, the button 118 may be moved in different ways, under different conditions, to provide different haptic outputs.

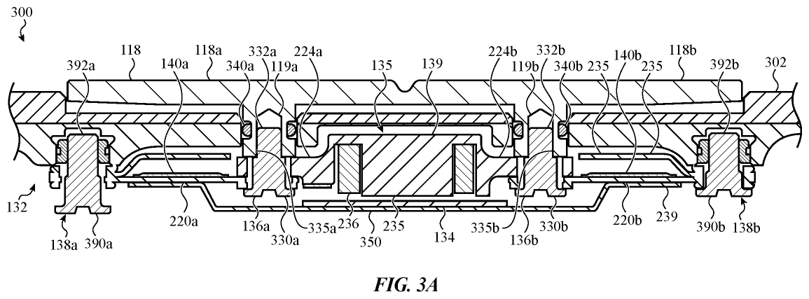

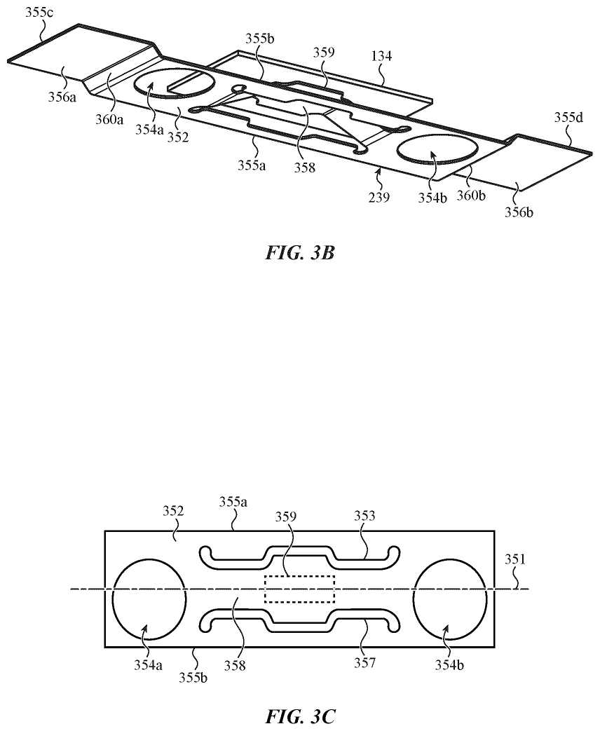

FIG. 3A shows a cross-sectional side view of an example haptic module 300 having a frame 235 including a main body 237 and a plate 239 for supporting a haptic engine 135. A button 118 may include shafts 119a, 119b that extend from the button 118 and through openings in a device housing 302. In some embodiments, the button 118 may have a user input surface that defines different actuation regions (e.g., first and second actuation regions 118a, 118b) that may be visually and/or tactilely distinct from one another (e.g., separated by a channel, ridge, groove, marking, bump, etc.).

The shafts 119a, 119b may be coupled to a base 132 that includes a pair of tabs 224a, 224b extending from a core 139 of the haptic engine 135, a pair of flexures 220a, 220b, and the frame 235. The first flexure 220a may have a first sensing element 140a thereon, and the second flexure 220b may have a second sensing element 140b thereon. The first flexure 220a and the second flexure 220b may be separate components that are coupled to the tabs 224a, 224b, and may be positioned on opposite sides of the haptic engine 135 proximate opposite ends of the frame 235. The first flexure 220a and the second flexure 220b may be rigidly coupled to the tabs 224a, 224b (e.g., via welds, fasteners, etc.). As described above, the sensing elements 140a, 140b may be or include strain gauges, or other components or materials that detect deflection of the base 132 (and more particularly, the two flexures 220a, 220b).

The haptic engine 135 may include an electromagnetic core 139, which may be formed from a ferromagnetic material, ferrimagnetic material, or other suitable material (e.g., iron, ferrite, steel, ferrous materials, permanent magnet, etc.). In some embodiments, the core 139 may be formed from an alloy including iron, cobalt, and/or vanadium. The haptic engine 135 may further include an electric coil 236 that surrounds a portion of the core 139. As described above, when tactile feedback (e.g., haptic output) is to be produced at the button 118, the electric coil 236 may be energized, which causes the core 139 to be attracted to the attraction plate 134.

The attraction plate 134 may be attached to the plate 239, interior to the frame 235. The attraction plate 134 may be welded, glued, or otherwise bonded to the plate 239. In some embodiments, the plate 239 may include or define one or more features (e.g., flexures) to which the attraction plate 134 is attached. In some embodiments, the plate 239 may have one or more slits therein, with the slits defining one or more flexures within the plate 239.

The button 118 may be coupled to the base 132 (e.g., to the tabs 224a, 224b) via a first set of fasteners 136a, 136b (e.g., screws). The fasteners 136a, 136b may secure the button 118 to the base 132 such that input forces applied to the button 118 are transferred to the base 132 through the respective shafts 119a, 119b. In some embodiments, the shafts 119a, 119b may have threaded cylindrical holes that extend into ends of the shafts 119a, 119b facing the base 132 (e.g., a top surface of the base 132). In some examples, each of the fasteners 136a, 136b may be a shoulder screw having a respective head 330a, 330b and a respective shoulder 335a, 335b. The respective shoulder 335a, 335b has a height that is sized to allow movement of the button 118 with respect to the base 132. A portion of each shoulder 335a, 335b that is distal from the head 330a, 330b may abut a respective end of a respective shaft 119a, 119b of the button 118. When the button 118 is at a first position with respect to the base 132, the ends of the shafts 119a, 119b may abut surfaces of the base 132 (e.g., portions of the tabs 224a, 224b), and the heights of the shoulders 335a, 335b prevent the heads 330a, 330b of the fasteners 136a, 136b from contacting the base 132 (e.g., portions of the flexures 220a, 220b), leaving respective gaps between the heads 330a, 330b of the fasteners 136a, 136b and the base 132. When the button 118 is at a second position with respect to the base 132, the heads 330a, 330b of the fasteners 136a, 136b abut surfaces of the base 132 (e.g., portions of the flexures 220a, 220b) and the heights of the shoulders 335a, 335b prevent the ends of the shafts 119a, 119b from contacting the base 132 (e.g., portions of the tabs 224a, 224b), leaving respective gaps between the ends of the shafts 119a, 119b and the base 132.

The input forces that are transferred to the base 132 in response to presses of the button 118 result in the flexures 220a, 220b deforming. The base 132 may be coupled to the device housing 302 via a second set of fasteners 138a, 138b. Each of the fasteners 138a, 138b may have a respective head 390a, 390b and a respective threaded shaft 392a, 392b extending from its respective head 390a, 390b. The heads 390a, 390b may engage with the base 132, and the threads of the threaded shafts 392a, 392b may engage respective threaded holes in the device housing 302, to secure the base 132 to the device housing 302.

FIG. 3B shows a bottom isometric view of an example base plate 239 of the haptic module 300, and FIG. 3C shows a bottom plan view of a central portion 352 of the base plate 239. The base plate 239 may optionally be bent (or otherwise formed) to define a central portion 352 and two distal portions 356a, 356b, with the distal portions 356a, 356b being disposed on opposite sides of the central portion 352. The base plate 239 may be bent (or double bent), at each transition 360a and 360b to distinguish the central portion 352 from the distal portions 356a, 356b. Alternatively, the base plate 239 may be flat or have other contours.

The base plate 239 may have a set of edges 355a, 355b, 355c, 355d that may be coupled (e.g., welded or crimped) to the main body 237 of the frame 235. A pair of apertures 354a, 354b in the central portion 352, near the transitions 360a, 360b, may allow the fasteners 136a, 136b to pass through the base plate 239 without contacting the base plate 239.

As shown in FIG. 3C, the central portion 352 of the base plate 239 may include a first slit 353 and a second slit 357 along the longitudinal axis 351. The first slit 353 and the second slit 357 may each include one or more non-linear or arcuate portion. In other embodiments, however, the first slit 353 and the second slit 357 may be linear in nature, or each formed by one or more intersecting linear slit segments. Each of the first and second slits 353, 357 may generally extend parallel to the longitudinal axis 351. In other embodiments, the first and second slits 353, 357 may be generally perpendicular to the longitudinal axis 351. Regardless, the first slit 353 and the second slit 357 define a flexure 358 therebetween. The flexure 358 may have an attachment portion 359 to which the attraction plate 134 may be attached (e.g., by one or more welds, glue, a compliant material, or other attachment means). The flexure 358 may provide a degree of compliance to accommodate movement of the attraction plate 134. Accordingly, in response to too great an input force on the button 118, when the core 139 deflects towards the attraction plate 134 and may under some conditions contact the attraction plate 134, the attraction plate 134 may move and prevent or mitigate damage to the core 139 and attraction plate 134. The flexure 358 may experience elastic deformation to accommodate the deflection of the core 139, and the elastic deformation may be relieved once the force on the button 118 is removed. The flexure 358 may be pre-deformed to have an arched shape, for example, as shown in FIG. 3B. This separates the attraction plate 134 from the surrounding portions of the base plate 239 (e.g., those portions of the base plate 239 that are adjacent the flexure 358).

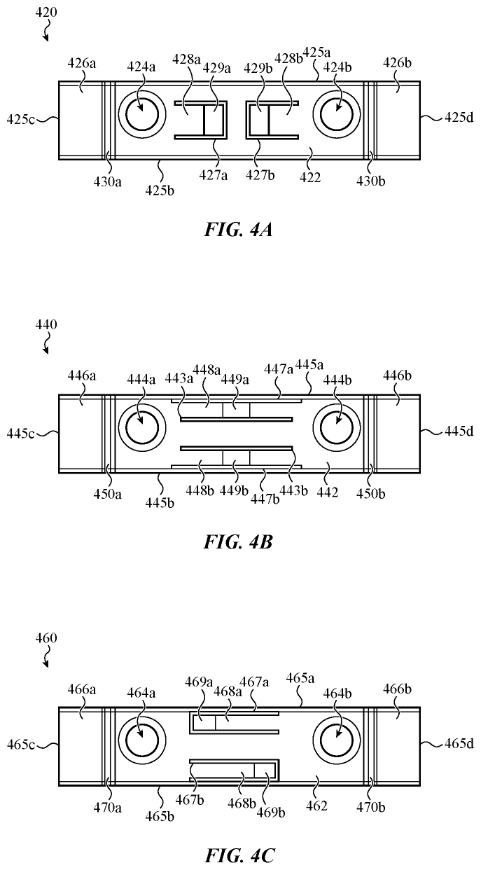

FIG. 4A shows a different example of a base plate 420 that can be used in a frame that supports an attraction plate (e.g., in the frame 235 described with reference to FIG. 3A, to support the attraction plate 134 of the haptic engine 135). The base plate 420 may optionally be bent (or otherwise formed) to define a central portion 422 and two distal portions 426a, 426b, with the distal portions 426a, 426b being disposed on opposite sides of the central portion 422. The base plate 420 may be bent (or double bent), at each transition 430a and 430b to distinguish the central portion 422 from the distal portions 426a, 426b. Alternatively, the base plate 420 may be flat or have other contours.

The base plate 420 may have a set of edges 425a, 425b, 425c, 425d that may be coupled (e.g., welded or crimped) to the main body 237 of the frame 235 described with reference to FIG. 3A. A pair of openings 424a, 424b in the central portion 422, near the transitions 430a, 430b, may allow fasteners to pass through the base plate 420 without contacting the base plate 420.

The central portion 422 of the base plate 420 may include a first slit 427a and a second slit 427b, each of which may have a U-shape (or squared off U-shape). The first U-shaped slit 427a defines a first cantilever 428a that faces toward the interior of the central portion 422. The second U-shaped slit 427b defines a second cantilever 428b that faces toward the interior of the central portion 422, in a direction opposite to and linearly aligned with the direction that the first cantilever 428a extends. Although the embodiment shown in FIG. 4A shows U-shaped slits 427a, 427b having square corners, they may not be limited as such. In different embodiments, each of the U-shaped slits 427a, 427b may include different linear, non-linear, or arcuate portions that define the first cantilever 428a and the second cantilever 428b.

The first and second cantilevers 428a, 428b may include respective attachment portions 429a, 429b at respective distal ends thereof. An attraction plate (e.g., the attraction plate 134) may be attached to the respective attachment portions 429a, 429b, and the cantilevers 428a, 428b may function as respective flexures that provide a degree of compliance to accommodate movement of the attraction plate 134.

FIG. 4B shows another example of a base plate 440 that can be used in a frame that supports an attraction plate (e.g., in the frame 235 described with reference to FIG. 3A, to support the attraction plate 134 of the haptic engine 135). The base plate 440 may optionally be bent (or otherwise formed) to define a central portion 442 and two distal portions 446a, 446b, with the distal portions 446a, 446b being disposed on opposite sides of the central portion 442. The base plate 440 may be bent (or double bent), at each transition 450a and 450b to distinguish the central portion 442 from the distal portions 446a, 446b. Alternatively, the base plate 440 may be flat or have other contours.

The base plate 440 may have a set of edges 445a, 445b, 445c, 445d that may be coupled (e.g., welded or crimped) to the main body 237 of the frame 235 described with reference to FIG. 3A. A pair of apertures 444a, 444b in the central portion 442, near the transitions 450a, 450b, may allow fasteners to pass through the base plate 440 without contacting the base plate 440.

The central portion 442 of the base plate 440 may include a first pair of slits 443a, 447a, generally parallel to the edge 445a, and a second pair of slits 443b, 447b, generally parallel to the edge 445b. In some embodiments, each slit in the first pair of slits 443a, 447a and the second pair of slits 443b, 447b may be linear in nature. In other embodiments, however, the slits in the first pair of slits 443a, 447a or the second pair of slits 443b, 447b may include one or more non-linear or arcuate portions. Regardless, the first pair of slits 443a, 447a may define a first flexure 448a and the second pair of slits 443b, 447b may define a second flexure 448b. The flexures 448a, 448b may have respective attachment portions 449a, 449b that can be attached to an attraction plate (e.g., the attraction plate 134).

FIG. 4C shows yet another example of a base plate 460 that can be used in a frame that supports an attraction plate (e.g., in the frame 235 described with reference to FIG. 3A, to support the attraction plate 134 of the haptic engine 135). The base plate 460 may optionally be bent (or otherwise formed) to define a central portion 462 and two distal portions 466a, 466b, with the distal portions 466a, 466b being disposed on opposite sides of the central portion 462. The base plate 460 may be bent (or double bent), at each transition 470a and 470b to distinguish the central portion 462 from the distal portions 466a, 466b. Alternatively, the base plate 460 may be flat or have other contours.

The base plate 460 may have a set of edges 465a, 465b, 465c, 465d that may be coupled (e.g., welded or crimped) to the main body 237 of the frame 235 described with reference to FIG. 3A. A pair of apertures 464a, 464b in the central portion 462, near the transitions 470a, 470b, may allow fasteners to pass through the base plate 460 without contacting the base plate 460.

The central portion 462 of the base plate 460 may include a first slit 467a and a second slit 467b, each of which may have a U-shape (or squared off U-shape). The first U-shaped slit 467a defines a first cantilever 468a that faces toward the interior of the central portion 462. The second U-shaped slit 467b defines a second cantilever 468b that faces toward the interior of the central portion 462, in a direction opposite, offset from, and parallel to the direction that the first cantilever 468a extends. Although the embodiment shown in FIG. 4C shows U-shaped slits 467a, 467b having square corners, they may not be limited as such. In different embodiments, each of the U-shaped slits 467a, 467b may include different linear, non-linear, or arcuate portions that define the first cantilever 468a and the second cantilever 468b.

The first and second cantilevers 468a, 468b may include respective attachment portions 469a, 469b at respective distal ends thereof. An attraction plate (e.g., the attraction plate 134) may be attached to the respective attachment portions 469a, 469b, and the cantilevers 468a, 468b may function as respective flexures that provide a degree of compliance to accommodate movement of the attraction plate 134.

FIG. 5 shows a cross-sectional side view of a right-hand portion 500 of a haptic module such as the haptic module described with reference to FIG. 3A. The portion 500 depicts a relationship between the haptic engine 135 and a base plate 550 of the frame 235 that supports the haptic engine 135. The haptic engine 135 may include an electromagnetic core 535 (substantially similar to the core described with reference to FIG. 3A) attached to the frame 235, an attraction plate 540 (substantially similar to the attraction plate described with reference to FIG. 3A), and an electric coil 534 (substantially similar to the electric coil described with reference to FIG. 3A) wound around at least a portion of the core 535. The electric coil 534, when energized, may create a magnetic field that causes a width of a gap 137 between the attraction plate 540 and the core 535 to temporarily change. A flexure 520 may extend from the core 535 and may include one or more sensors (not shown). The core 535 may be attached to a button (not shown) by means of a fastener 536.

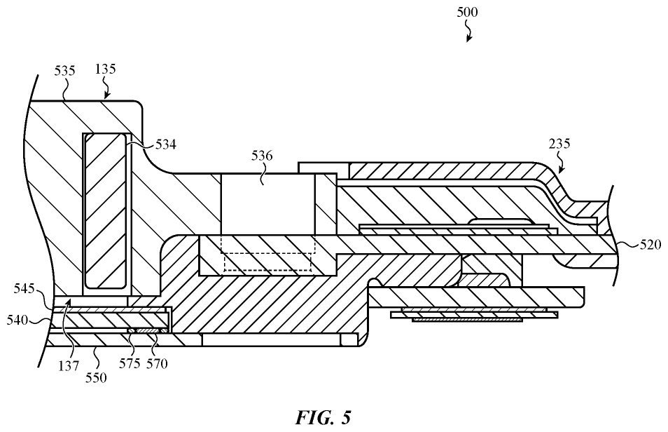

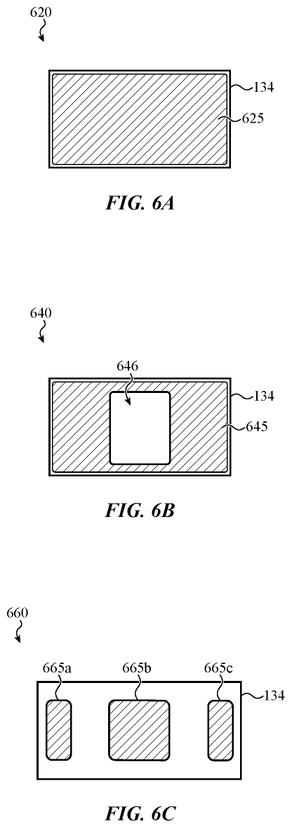

The attraction plate 540 may be disposed interior to the frame 235 and may be attached to the base plate 550 (and thereby coupled to the frame 235), as described, for example, with reference to FIGS. 3A and 4C. In response to an input force applied to a button attached to the core 535, the core 535 may be deflected towards the attraction plate 540, thereby reducing the gap 137. A cushioning pad 545 may be attached to a surface of the attraction plate 540 facing the gap 137, and additionally or alternatively, a separate cushioning pad 545 may be attached to a surface of the core 535 that faces the attraction plate 540. The cushioning pad(s) 545 may be made from a material that has a lower hardness than a material (e.g., a metal or alloy) of both the core 535 and the attraction plate 540, such that the cushioning pad(s) 545 mitigate(s) damage due to a potential crash between the attraction plate 540 and the core 535. As non-limiting examples, the cushioning pad 545 may include a foam, polyethylene terephthalate, polyimide, silicone, a pressure-sensitive adhesive, or other material. In some embodiments, the cushioning pad 545 may fill the entire gap 137 (e.g., when made from a material that can be sufficiently compressed to accommodate the movement of the core 535 towards the attraction plate 540 when receiving a button press or delivering a haptic output). Various examples of the cushioning pad 545 are described with respect to FIGS. 6A and 6C.

One or more welds may be used to attach various portions of the haptic module 300. For example, as shown in FIG. 5, the attraction plate 540 may be attached to the base plate 550 using one or more welds 570. While the weld 570 is shown with respect to the right-hand portion 500 of the haptic module 300, a similar weld may be present on a left-hand portion (not shown) of the haptic module 300. Further, in some embodiments, the weld 570 may be reinforced by glue 575 disposed along a perimeter of the weld 570. The glue 575 may provide additional structural robustness to the weld 570 and move stresses due to movement of the attraction plate 540 with respect to the base plate 550 away from the weld 570, such that the weld 570 is less likely to crack over repeated uses of a haptic module including the portion 500.

FIGS. 6A-6C show top views of three example cushioning pads that may be used as the cushioning pad disposed on the attraction plate 134 described with reference to FIG. 3A. The cushioning pads may provide a compliant interface therebetween during user inputs and haptic outputs. For example, as shown in FIG. 6A, the cushioning pad 620 may include a layer 625 of material that spans an entire surface area, or substantial portion thereof (e.g., more than 50%, 75%, or 90%, of a component (core or attraction plate) facing a gap between the core 139 and the attraction plate 134. In some embodiments, the cushioning pad 620 may have a surface area that is equal to or greater than a surface area of the core 139 facing the gap 137, or equal to, greater than, or about the same size as a width of the gap 137.

As another example, and as shown in FIG. 6B, the cushioning pad 640 may include a layer 645 of material that has a cutout 646 or other feature. The cutout 646 may be provided to remove material between portions of a core 139 and attraction plate 134 where attraction forces are the greatest, so that the cushioning pad 640 does not diminish these attraction forces.

As yet another example, and as shown in FIG. 6C, multiple portions 665a, 665b, 665c may be provided on the attraction plate 134 to form a cushioning pad assembly 660.

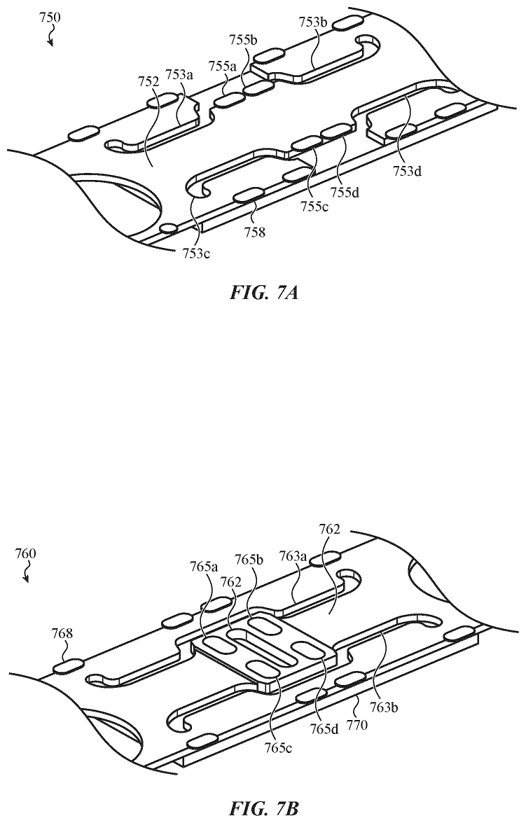

FIGS. 7A and 7B show bottom isometric views of an example portion of a base plate 750 attached to an attraction plate 740. As shown in FIG. 7A, the base plate 750 may include a set of slits 753a, 753b, 753c, 753d that define a flexure 752 (or multiple flexures) within the base plate 750. Each slit 753a, 753b, 753c, 753d may be linear or non-linear.

The attraction plate 740 may be welded to the flexure 752 at a set of welds 755a, 755b, 755c, 755d. Exterior edges of the welds 755a, 755b, 755c, 755d may be left exposed by removing portions of the sides of the base plate 750, so that glue may be applied to the exterior edges of the welds 755a, 755b, 755c, 755d and, in some cases, injected between the base plate 750 and the attraction plate 740 to surround the welds 755a, 755b, 755c, 755d. Additional welds (e.g., weld 758) may be used along the edges of the base plate 750 to attach the base plate 750 to main body or other portion of a frame.

As shown in FIG. 7B, the base plate 760 may include a set of slits 763a, 763b that define a flexure 762 (or multiple flexures) within the base plate 760. Each slit 763a, 763b may be linear or non-linear.

The attraction plate 770 may be welded to the flexure 762 at a set of welds 765a, 765b, 765c, 765d. A glue injection port 761 may be formed in the flexure 762, between the welds 765a, 765b, 765c, 765d, so that glue may be applied around the welds 765a, 765b, 765c, 765d by injecting the glue into the glue injection port 761. Additional welds (e.g., weld 768) may be used along the edges of the base plate 760 to attach the base plate 760 to a main body or other portion of a frame.

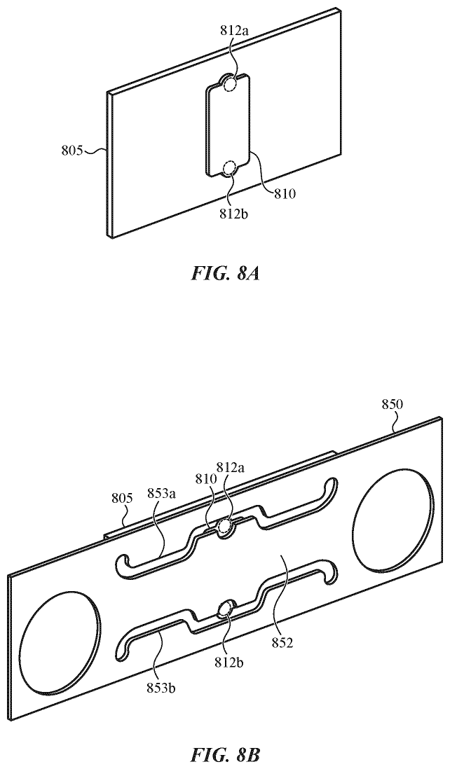

FIG. 8A shows a bottom isometric view of an example spacer 810 coupled to an attraction plate 805 of a haptic engine, while FIG. 8B shows a bottom isometric view of the spacer 810, with attached attraction plate 805, coupled to a base plate 850 of a frame that houses the haptic engine (e.g., with the spacer 810 disposed between the attraction plate 805 and the base plate 850. The base plate 850 may include a set of slits 853a, 853b that define a flexure 852 (or multiple flexures) within the base plate 850. Each slit 853a, 853b may be linear or non-linear.

The spacer 810 may have a first surface attached to the attraction plate 805 and a second surface attached to the base plate 850. In some embodiments, the spacer 810 may include metal and may be attached to the attraction plate 805 by welds 812a, 812b (e.g., possibly in combination with glue around the welds). The same or different welds 812a, 812b may attach the spacer 810 to the base plate 850. In other embodiments, the spacer 810 may be a compliant material such as, but not limited to, a gel, or a silicone overmolded on a portion of the base plate 850 or the attraction plate 805. In these embodiments, the welds 812a, 812b are not needed.

FIG. 9 shows a cross-sectional side view of an example haptic module 900, in which an attraction plate 934 of a haptic engine 135 is disposed between a core 935 of the haptic engine 135 and a device housing 302 of a device that includes the haptic module 900. The example haptic module 900 may otherwise be similar to the haptic module described with reference to FIG. 3A. However, the position of the attraction plate 934, between the core 935 and the device housing 302, mitigates the prospect of a crash between the attraction plate 934 and the core 935, because a press on the button 118 moves the core 935 away from the attraction plate 934 rather than toward the attraction plate 934.

The haptic module 900 may include a frame 235 positioned internal to the device housing 302. A button 118 may be positioned external to the device housing 302 and may be coupled to the core 935 through one or more openings 915a, 915b defined by the device housing 302. One or more shafts 119a, 119b extending from the button 118 may protrude through the openings 915a, 915b and be fastened to the core 935. The haptic engine 135 may be at least partially enclosed by the frame 235. The haptic engine 135 may include the core 935, the attraction plate 934, and an electric coil 936. The attraction plate 934 may be separated from the core 935 by a gap 950. A cushioning pad may be positioned between the attraction plate 934 and the core 935, as described with reference to FIGS. 5 and 6A-6C.

The core 935 may define a cavity 937 that opens towards the attraction plate 934. An electric coil 936 may be disposed in the cavity 937 and wound around a portion of the core 935. The electric coil 936, when energized, may create a magnetic field that causes a width of the gap 950 to temporarily change. In response to an input force on the button 118, the core 935 may deflect away from the attraction plate 934 and increase the size of the gap 950. By increasing, rather than decreasing, the gap 950 between the attraction plate 934 and the core 935, the example haptic module 900 mitigates the chance that the core 935 may crash into the attraction plate 934. In some cases, the arrangement of parts shown in FIG. 9 may also reduce the size of the haptic module 900, as it may be mounted in closer proximity to the device housing 302.

Various embodiments are described with reference to the attached figures, where like reference numerals are used throughout the figures to designate similar or equivalent elements. The figures are not necessarily drawn to scale and are provided merely to illustrate aspects and features of the present disclosure. Numerous specific details, relationships, and methods are set forth to provide a full understanding of certain aspects and features of the present disclosure, although one having ordinary skill in the relevant art will recognize that these aspects and features can be practiced without one or more of the specific details, with other relationships, or with other methods. In some instances, well-known structures or operations are not shown in detail for illustrative purposes. The various embodiments disclosed herein are not necessarily limited by the illustrated ordering of acts or events, as some acts may occur in different orders and/or concurrently with other acts or events. Furthermore, not all illustrated acts or events are necessarily required to implement certain aspects and features of the present disclosure.

For purposes of the present detailed description, unless specifically disclaimed, and where appropriate, the singular includes the plural and vice versa. The word “including” means “including without limitation.” Moreover, words of approximation, such as “about,” “almost,” “substantially,” “approximately,” and the like, can be used herein to mean “at,” “near,” “nearly at,” “within 3-5% of,” “within acceptable manufacturing tolerances of,” or any logical combination thereof. Similarly, terms “vertical” or “horizontal” are intended to additionally include “within 3-5% of” a vertical or horizontal orientation, respectively.

Additionally, directional terminology, such as “top”, “bottom”, “upper”, “lower”, “front”, “back”, “over”, “under”, “above”, “below”, “left”, “right”, etc. is used with reference to the orientation of some of the components in some of the figures described below. Because components in various embodiments can be positioned in a number of different orientations, directional terminology is used for purposes of illustration only and is in no way limiting. The directional terminology is intended to be construed broadly, and therefore should not be interpreted to preclude components being oriented in different ways. These words are intended to relate to the equivalent direction as depicted in a reference illustration; as understood contextually from the object(s) or element(s) being referenced, such as from a commonly used position for the object(s) or element(s); or as otherwise described herein. Further, it is noted that the term “signal” means a waveform (e.g., electrical, optical, magnetic, mechanical, or electromagnetic) capable of traveling through a medium such as DC, AC, sinusoidal-wave, triangular-wave, square-wave, vibration, and the like.

Also, as used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

The foregoing description, for purposes of explanation, uses specific nomenclature to provide a thorough understanding of the described embodiments. However, it will be apparent to one skilled in the art, after reading this description, that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art, after reading this description, that many modifications and variations are possible in view of the above teachings.

Although the disclosed embodiments have been illustrated and described with respect to one or more implementations, equivalent alterations and modifications will occur or be known to others skilled in the art upon the reading and understanding of this specification and the annexed drawings. In addition, while a particular feature is disclosed with respect to only one of several implementations, such feature may be combined with one or more other features of the other implementations as may be desired and advantageous for any given or particular application.

While various embodiments of the present disclosure have been described above, it should be understood that they have been presented by way of example only, and not limitation. Numerous changes to the disclosed embodiments can be made in accordance with the disclosure herein, without departing from the spirit or scope of the disclosure. Thus, the breadth and scope of the present disclosure should not be limited by any of the above-described embodiments. Rather, the scope of the disclosure should be defined in accordance with the following claims and their equivalents.

What is claimed is:

1. A device, comprising:
a frame defining at least one flexure; and
a haptic engine, including:
a core attached to the frame;
an attraction plate attached to the at least one flexure, the attraction plate separated from the core by a gap; and
an electric coil wound around at least a portion of the core that, when energized, creates a magnetic field that causes a width of the gap to temporarily change.

2. The device of claim 1, wherein:
the frame comprises a plate; and
the at least one flexure comprises a flexure defined by a portion of the plate disposed between a pair of slits in the plate.

3. The device of claim 2, wherein at least one slit of the pair of slits has a non-linear or arcuate portion.

4. The device of claim 1, wherein:
the frame comprises a plate; and
the at least one flexure comprises:
a first flexure defined by a first portion of the plate disposed between a first pair of slits in the plate; and
a second flexure defined by a second portion of the plate disposed between a second pair of slits in the plate.

5. The device of claim 1, wherein:
the frame comprises a plate; and
the at least one flexure comprises at least one cantilever defined by at least one slit in the plate.

6. The device of claim 5, wherein the at least one cantilever comprises:
a first cantilever disposed proximate to a first side of the plate and having a first attachment portion at a distal end thereof for attaching the attraction plate; and
a second cantilever disposed proximate to a second side of the plate and having a second attachment portion at a distal end thereof for attaching the attraction plate, the second side being opposite to the first side.

7. The device of claim 5, wherein the at least one cantilever comprises:
a first cantilever disposed along a first edge of the plate and having a first attachment portion at a distal end thereof for attaching the attraction plate; and
a second cantilever disposed along a second edge of the plate, parallel to the first cantilever, and having a second attachment portion at a distal end thereof for attaching the attraction plate, the second edge being opposite to the first edge.

8. The device of claim 1, wherein:
the frame comprises a plate; and
the at least one flexure comprises a first portion of the plate that has a smaller width than a second portion of the plate.

9. A device, comprising:
a frame;
a haptic engine, including:
a core coupled to the frame;
an attraction plate coupled to the frame, interior to the frame, and separated from the core by a gap; and
an electric coil wound around at least a portion of the core that, when energized, creates a magnetic field that causes a width of the gap to temporarily change.

10. The device of claim 9, wherein:
the attraction plate is attached to the frame by at least one weld; and
the device further comprises glue disposed along a perimeter of the at least one weld.

11. The device of claim 10, wherein the frame defines a glue injection port in a portion of the frame adjacent the attraction plate.

12. The device of claim 9, further comprising a spacer disposed between the attraction plate and the frame, wherein the attraction plate is attached to the spacer, and the spacer is attached to the frame.

13. The device of claim 9, further comprising:
a device housing defining an opening; and
a button positioned external to the device housing and coupled to the frame through the opening, wherein in response to an input force applied on the button, the core is deflected towards the attraction plate, thereby reducing the gap.

14. A device, comprising:
a frame;
a haptic engine, including:
a core attached to the frame;
an attraction plate attached to the frame and separated from a surface of the core by a gap; and
an electric coil wound around at least a portion of the core that, when energized, causes a width of the gap to temporarily change; and
a cushioning pad positioned within the gap, on at least one of the attraction plate or the surface of the core.

15. The device of claim 14, wherein the cushioning pad comprises a first material that has a lower hardness than a second material of the core and a third material of the attraction plate.

16. The device of claim 15, wherein the first material includes at least one of: a foam, polyethylene terephthalate, polyimide, silicone, a pressure-sensitive adhesive, or any combination thereof.

17. The device of claim 14, wherein the cushioning pad spans a width of the gap.

18. The device of claim 14, wherein the cushioning pad has a surface area greater than a portion of the surface of the core that abuts the gap.

19. A device, comprising:
a frame;
a haptic engine, including:
a core attached to the frame;
an attraction plate separated from a surface of the core by a gap; and
an electric coil wound around at least a portion of the core that, when energized, creates a magnetic field that causes a width of the gap to temporarily change; and
a layer of a compliant material attaching the attraction plate to the frame.

20. The device of claim 19, wherein the compliant material comprises a gel.

21. The device of claim 19, wherein the compliant material comprises a silicone overmolded on a portion of the frame or the attraction plate.

22. A device, comprising:
a device housing;
a frame positioned internal to the device housing; and
a haptic engine including:
a core attached to the frame;
an attraction plate disposed between the device housing and the core, the attraction plate separated from the core by a gap; and
an electric coil wound around at least a portion of the core that, when energized, creates a magnetic field that causes a width of the gap to temporarily change.

23. The device of claim 22, wherein:
the core defines a cavity facing the attraction plate; and
the electric coil is disposed in the cavity.

24. The device of claim 22, further comprising:
a button positioned external to the device housing and coupled to the frame through an opening defined by the device housing, wherein in response to an input force applied on the button, the core is deflected away from the attraction plate, thereby increasing the gap.
